(19) United States
(12) Patent Application Publication
(10) Pub. No.: US 2008/0265006 A1
(43) Pub. Date: Oct. 30, 2008

(54) Method for bonding electronic components finished with electroless NiXP for preventing brittle fracture

(76) Inventors: Jin Yu, Daejeon (KR); Dong-Min Jang, Daejeon (KR); Young-Kun Jee, Daejeon (KR)

Correspondence Address: NATH & ASSOCIATES, 112 South West Street, Alexandria, VA, 22314, US

(21) Appl. No.: 11/878,173

(22) Filed: Jul. 20, 2007

(30) Foreign Application Priority Data
Apr. 27, 2007 (KR) 10-2007-0041498

(51) Int. Cl. B23K 1/20; B23K 31/02

(52) U.S. Cl. 228/203

(57) ABSTRACT

A method for bonding electronic components finished with electroless NiXP layer for preventing a brittle solder joint fracture is provided with the steps comprising: forming an electroless NiXP metal layer on a metal deposition of electronic components, wherein X is selected from the group consisting of W, Mo, Co, Ti, Zr, Zn, V, Cr, Fe, Nb, Re, Mn, Tl and Cu; and reflowing a lead-free solder on the electroless NiXP layer to be bonded. X element was suppressed the formation of Ni3P, Ni3SnP intermetallic compound and prevented the spalling behavior of Ni3Sn4. Therefore, solder joint reliability can be improved significantly.

### CROSS-REFERENCE TO RELATED APPLICATIONS

The present invention claims priority to Korean Patent Application No. 2007-41498 filed on Apr. 27, 2007, which is incorporated herein by reference in its entirety.

### BACKGROUND OF THE INVENTION

1. Field of the Invention

The present invention relates, generally, to methods for preventing a brittle fracture occurring at a solder joint after electronic components finished with modified Electroless NiXP (X═W, Mo, Co, Ti, Zr, Zn, V, Cr, Fe, Nb, Re, Mn, TI and Cu) are bonded to a solder. The present invention has an object to prevent a brittle fracture occurring at a solder joint by simultaneously depositing electroless NiXP adding a salt including the above metals to electroless nickel bath and inhibiting the spalling of intermetallic compounds formed at the time of bonding with a solder and keeping Ni₃P and NiSnP layers from being formed.

2. Description of the Related Art

A Pb—Sn alloy has been used as a representative solder material at a conventional bonding using a solder but a lead is recently regulated in electronic components due to the harm of a lead. Therefore, a lead-free solder has been continuously developed and currently Sn—Ag, Sn—Cu, Sn—Ag—Cu, Sn—Zn and Sn—Zn—Bi based lead-free solders are substituting a Pb—Sn solder.

In the meantime, the development of UBM for lead-free solder is also on a progress simultaneously and Cr/Cr—Cu/Cu, Ti—W/Cu electrolytic Cu and Al/Ni—V/Cu etc. are representatively used in a chip side portion whereas electrolytic nickel, electroless nickel, OSP (Organic solderability preservative)-treated electrolytic copper etc. are used in a BGA package and a print circuit board. The estimation of interfacial reaction between the above-mentioned lead-free solder and UBM and the reliability is performed by a lot of researchers. The copper-based UBM forms a thick intermetallic compound at an interface when it reacts with a lead-free solder, and therefore it is known that nickel-based UBM is more appropriate for a lead-free solder. Currently, electroless nickel is more widely used as UBM than electrolytic nickel in view of costs, but it becomes a serious problem that a brittle fracture occurs at a solder joint when electroless nickel is reacted with a solder. This problem has been researched by Y. S. Shon et al. in “Correlation between chemical reaction and brittle fracture found in electroless Ni(P)/immersion gold-solder interconnection” J. Mater. Res. 20, 8, 1931, 2005. It was reported that if an electroless nickel layer is reacted with Sn-3.5Ag solder, Ni₃Sn₄ intermetallic compound, Ni₃SnP and Ni₃P phases are formed and then Ni₃Sn₄ is separated from the interface so that a brittle fracture occurs. A continuous research and development are currently performed in order to determine the optimum combination of lead-free solder and UBM. Especially, a bonding technology using a solder in portable electronic devices which have higher performance, higher functionalization and ultra miniaturization is to generalize and a request for a strong solder joint which endures mechanical impacts increases.

Y. S. Shon et al. of US2006/0024943A1 of the prior art related to the present invention suggested a method for preventing intermetallic compounds from spalling. In order to prevent a brittle fracture at a joint of electroless nickel and a solder, an additional electrolytic/electroless copper layer is deposited on electroless nickel UBM and thus, improving the reliability. However, it has a trouble of additional depositing a Cu layer but in the present invention, a metal salt to be deposited is added into an electroless nickel solution and is simultaneously co-deposited with nickel. Therefore, the prior art has a configuration different from the present invention.

### SUMMARY OF THE INVENTION

In case of Sn-based solder, the formation of Ni₃P and NiSnP layers at the time of bonding with an electroless Ni(P) layer become a reason of causing a brittle fracture at a joint. Accordingly, the present invention is directed to provide with a method for preventing a brittle fracture at a joint by adding atoms reacting with P to prevent a formation of Ni₃P and NiSnP layers and for improving a mechanical reliability.

The present invention provides with a method for bonding electronic components finished with electroless NiXP using a solder for preventing a brittle fracture, the method comprising: forming an electroless NiXP metal layer on a metal deposition of electronic components; and reflowing a lead-free solder on the electroless NiXP layer to be bonded.

The method is characterized to be used in bonding of electronic components between a semiconductor chip and a package component, between a package component and a print circuit board or between a semiconductor chip and a print circuit board.

The solder bonded on a nickel layer is SnAg, SnAgCu, SnAgZn, SnAgAl, SnAgBe, SnAgSi, SnAgGe, SnAgMg, SnCu, SnBi, SnZn or SnZnBi-based solder, and may use Ag of 0˜10 wt %, Zn of 0˜10 wt %, Al of 1˜5 wt %, Be of 1˜5 wt %, Si of 8˜15 wt %, Ge of 8˜15 wt %, Mg of 1˜7 wt %, Cu of 0˜2 wt %, and Bi of 0˜58 wt %.

The present invention provides with a method for bonding electronic components characterized in that a salt of metal selected from the group consisting of W, Mo, Co, Ti, Zr, Zn, V, Cr, Fe, Nb, Re, Mn, Tl and Cu is added to an electroless nickel plating bath, and NiXP layer is plated on metal deposition, where the X is a metal selected from the group consisting of W, Mo, Co, Ti, Zr, Zn, V, Cr, Fe, Nb, Re, Mn, Tl and Cu.

An electroless NiXP thin film with the composition ranges of W of 1˜20 wt %, Mo of 1˜30 wt %, Co of 1˜50 wt %, Zn of 1˜10 wt %, Fe of 1˜40 wt %, Re of 1˜50 wt %, Mn of 0.5˜5 wt %, Cr of 0.5˜10 wt %, Tl of 1˜20 wt %, Cu of 1˜20 wt % and Ti, Zr, V and Nb of 1˜20 wt %, respectively may be used.

The present invention may deposit Au, Au or Pd with the thickness of 1 um or less for improving the wettability with a solder on the electroless NiXP UBM and for keeping the NiXP from being oxidized.

### BRIEF DESCRIPTION OF THE DRAWINGS

FIG. 1 is a schematic view showing a process for bonding package components finished with electroless NiXP to a solder;

FIG. 1A shows a step for forming electroless NiXP on a metal deposition of a BGA package;

FIG. 1B shows a step for forming a solder on (A);

FIG. 1C shows a step for bonding the BGA package formed in the step (B) to a surface-treated print circuit board formed in the step (A) with electroless NiXP with a reflow process;

FIG. 2 is a photograph of a cross-section at the time of reacting with the solder according to each UBM;

FIG. 2A is a photograph where electroless nickel and Sn3.5Ag solder are reflowed for 5 minutes at 260° C. and FIGS. 2B, 2C, 2D, 2E, 2F and 2G are photographs where electroless NiWP, NiMoP, NiMnP, NiReP, NiReWP, NiFeP and Sn3.5Ag solders are reflowed at 260° C. for one or five minutes;

FIG. 3 is a photograph of a cross-section passed an impact test according to UBM;

FIG. 3A is a photograph of the cross-section of a specimen passed an impact test after reflowing electroless nickel and Sn3.5Ag solder at 260° C. for 300 seconds;

FIG. 3B is a photograph of the cross-section of a specimen passed an impact test after reflowing electroless NiWP and Sn3.5Ag solder under the same condition.

### DETAILED DESCRIPTION OF THE INVENTION

Hereinafter, the contents of the present invention now will be described in detail.

The present invention is directed to a method for preventing a brittle fracture when electroless nickel is bonded with surface-treated electronic components, and comprises:

Adding a salt of metal selected from the group consisting of W, Mo, Co, Ti, Zr, Zn, V, Cr, Fe, Nb, Re, Mn, Ti and Cu into an electroless nickel plating bath, plating an NiXP layer on a metal deposition, where the X is a metal selected from the group consisting of W, Mo, Co, Ti, Zr, Zn, V, Cr, Fe, Nb, Re, Mn, Tl and Cu, and reflowing a lead-free solder to the NiXP UBM to bond the print circuit boards at both sides mutually.

A better understanding of the present invention may be obtained with reference to the drawings, which are attached to illustrate, but not to limit the scope of the present invention.

The table 1 showed the solution composition for electroless plating of NiWP, NiMoP, NiMnP, NiFeP, NiReP and NiReWP and the plating conditions thereof.

TABLE 1
solution for forming NiXP layer

| | (g/L) | | | | | |
|---|---|---|---|---|---|---|
| | NiWP | NiMoP | NiMnP | NiFeP | NiReP | NiReWP |
| NiSO₄6H₂O | 7 | 20 | 2.63 | 10 | 35 | 35 |
| NaH₂PO₂H₂O | 10 | 17.6 | 17.6 | 20 | 10 | 10 |
| Na₂WO₄2H₂O | 35 | — | — | — | — | 2 |
| Na₂MoO₄6H₂O | — | 2.42 | — | — | — | — |
| FeSO₄7H₂O | — | — | — | 10 | — | — |
| KReO₄ | — | — | — | — | 0.3 | 0.3 |
| MnSO₄H₂O | — | — | 6.76 | — | — | — |
| Na₃C₆H₈O₇2H₂O | 40 | 20.6 | — | 60 | 85 | 85 |
| NaC₆H₁₁O₇H₂O | — | 2.18 | — | — | — | — |
| Na₂C₄H₄O₅H₂O | — | — | 8.9 | — | — | — |
| Na₂C₃H₂O₄H₂O | — | — | 74 | — | — | — |
| (NH₄)₂SO₄ | — | — | 66 | — | — | — |
| H₃BO₃ | — | — | — | 30 | — | — |
| NH₄Cl | — | — | — | — | 50 | 50 |
| NH₄OH | — | — | — | — | 50 ml | 50 ml |
| pH/Temp | 8.2/86° C. | 9/86° C. | 9.6/86° C. | 90° C. | 9.2/86° C. | 9.2/86° C. |

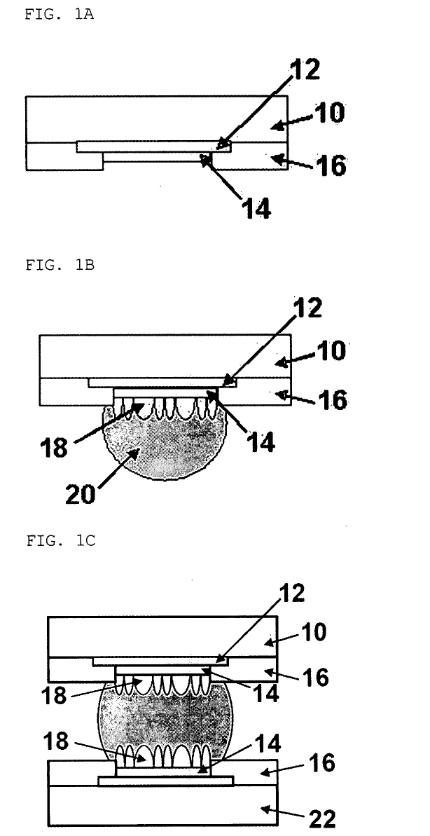

FIG. 1 is a schematic view showing a process for bonding a print circuit board finished with electroless NiXP, first, an electroless NiXP layer (14) is formed on a metal deposition (12) of a BGA package (10) (in FIG. 1A). A Sn3.5Ag solder (20) is reflowed on the formed electroless NiXP layer (in FIG. 1B). A print circuit board used in the lower side also equally deposits an NiXP layer and align it with the solder of the upper package components to reflow them to be bonded (in FIG. 1C).

In FIGS. 1A to 1C, the numeral 10 refers to a BGA package, 12 to a metal deposition, 14 to electroless Ni—W—P, 16 to a solder mask, 18 to Ni₃Sn₄ intermetallic compounds, 20 to a Sn3.5Ag solder and 22 to a print circuit board.

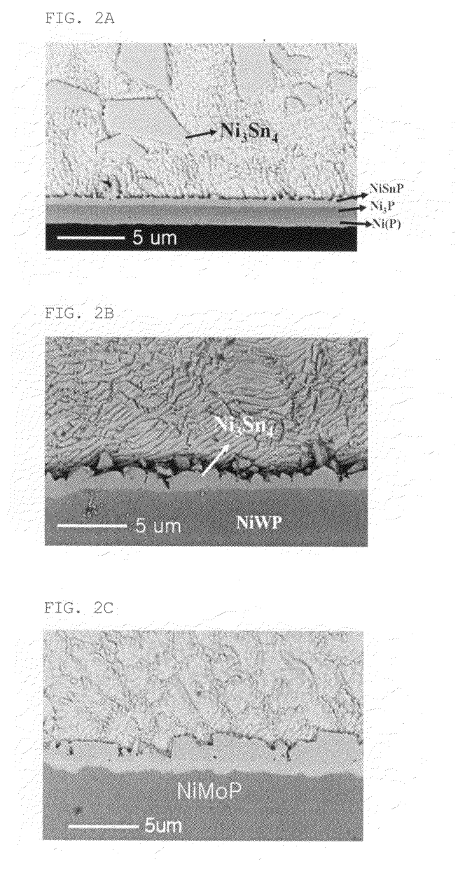

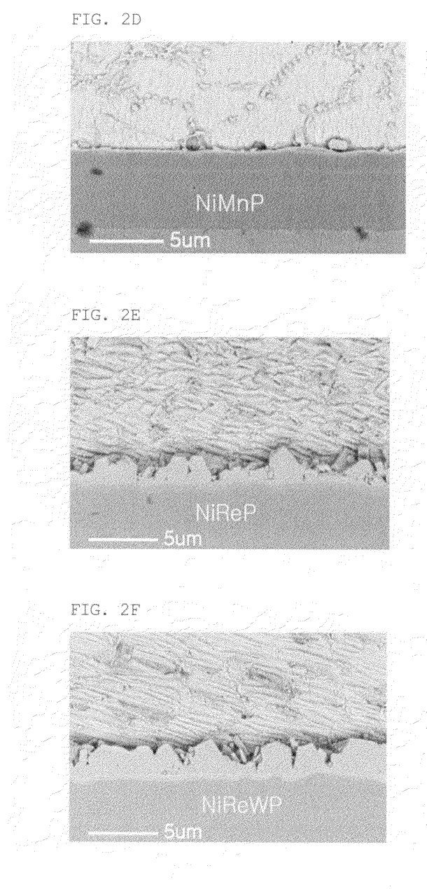

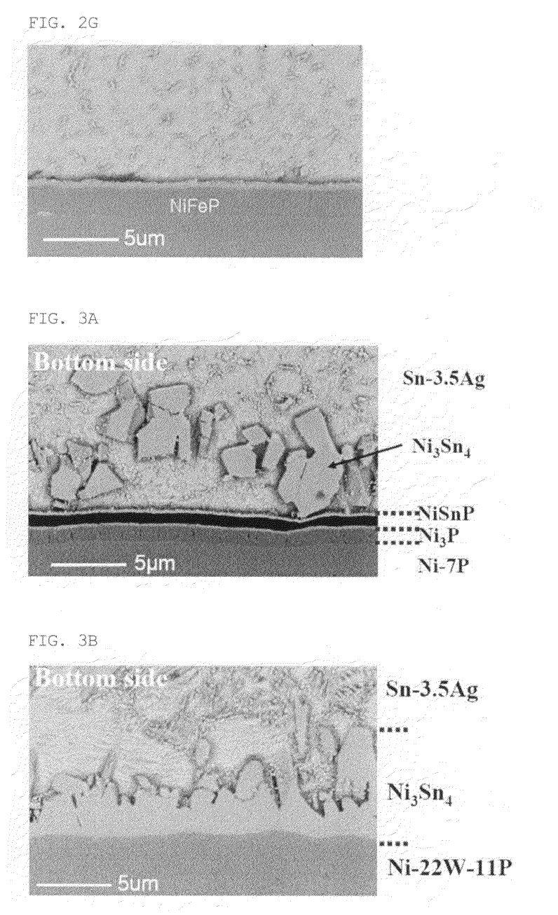

When the conventionally used electroless nickel is bonded with a SnAg or PbSn-based solder, a Ni₃Sn₄ intermetallic compound is formed at a solder joint. Thus, on the electroless nickel layer is formed a Ni₃P layer, on which a NiSnP layer is formed. As the reaction proceeds, the NiSnP layer gets thicker and the intermetallic compounds spalling is happened. FIG. 2A shows a picture of a cross-section when the electroless nickel and Sn3.5Ag solder paste is reflowed at 260° C. for five minutes, and all Ni₃Sn₄ intermetallic compounds spalled from the NiSnP layer. This phenomenon is very closely related to the brittle fracture of a solder joint. In order to control the phenomenon, if the electroless NiXP layer is deposited and reflowed 260° C. for one or five minutes, the intermetallic compounds do not spall at all nor NiSnP layer was mostly observed as shown in FIGS. 2B to 2G. The reason why the above atoms were selected is that when bonded with a solder, they are reacted with P to produce intermetallic compounds. Therefore, it is possible to keep Ni₃P and NiSnP layers which are closely related to a brittle fracture of a joint from being formed. The above way where other metals are added on an electroless nickel layer to keep intermetallic compounds from spalling and NiSnP layer is not formed can be suggested as a method capable of controlling a brittle fracture at a solder joint, which have been already reported.

An impact test was performed in order to confirm that a brittle fracture at a solder joint is prevented. The upper and lower print circuit boards form a UBM by adding tungsten on the electroless nickel layer and were bonded at 260° C. for 300 seconds using a Sn3.5Ag solder ball. In order to get comparison results, the conventionally used electroless nickel layer was used as a UBM to manufacture the same specimen. As a result of the drop impact test, it was confirmed that a brittle fracture occurs at the 39 times in a specimen using the electroless nickel layer as a UBM.

FIG. 3A is a photograph of the cross-section of a specimen where spalling occurs and shows that the intermetallic compounds spall in the same way as reported earlier and a brittle fracture occurs in a NiSnP layer. However, in case that an electroless nickel layer is added by tungsten to form a UBM, it was confirmed that the brittle fracture did not occur even if it is dropped above 400 times.

FIG. 3B is a photograph of the cross-section, and it is known that the intermetallic compounds do not spall and are well combined with an electroless NiWP layer.

The present invention solves the problem of a brittle fracture which frequently occurs at the electroless Ni(P)/solder joint of an electronic package and thus improves the reliability of the electronic devices.

What is claimed is:

1. A method for bonding electronic components finished with electroless Ni(P) layer using a solder for preventing a brittle fracture, the method comprising:
forming an electroless NiXP metal layer on a metal deposition of electronic components, wherein X is selected from the group consisting of W, Mo, Co, Ti, Zr, Zn, V, Cr, Fe, Nb, Re, Mn, Tl and Cu; and
reflowing a lead-free solder on the electroless NiXP layer to be bonded.

2. The method as set forth in claim 1, wherein the bonding of electronic components is used between a semiconductor chip and a package component, between a package component and a print circuit board or between a semiconductor chip and a print circuit board.

3. The method as set forth in claim 1, wherein the solder bonded on a nickel layer is SnAg, SnAgCu, SnAgZn, SnAgAl, SnAgBe, SnAgSi, SnAgGe, SnAgMg, SnCu, SnBi, SnZn or SnZnBi-based solder, and may use Ag of 0˜10 wt %, Zn of 0˜10 wt %, Al of 1˜5 wt %, Be of 1˜5 wt %, Si of 8˜15 wt %, Ge of 8˜15 wt %, Mg of 1˜7 wt %, Cu of 0˜2 wt %, and Bi of 0˜58 wt %.

4. A method for bonding electronic components characterized in that a salt of metal selected from the group consisting of W, Mo, Co, Ti, Zr, Zn, V, Cr, Fe, Nb, Re, Mn, Tl and Cu is added to an electroless nickel plating bath, and an NiXP layer is plated on metal deposition, where the X is a metal selected from the group consisting of W, Mo, Co, Ti, Zr, Zn, V, Cr, Fe, Nb, Re, Mn, Tl and Cu.

5. The method as set forth in claim 4, wherein the composition ranges of the atoms of an electroless NiXP thin film are W of 1˜20 wt %, Mo of 1˜30 wt %, Co of 1˜50 wt %, Zn of 1˜10 wt %, Fe of 1˜40 wt %, Re of 1˜50 wt %, Mn of 0.5˜5 wt %, Cr of 0.5˜10 wt %, Tl of 1˜20 wt %, Cu of 1˜20 wt % and Ti, Zr, V and Nb of 1˜20 wt %, respectively.

6. A method for bonding electronic components, wherein Au, Au or Pd with the thickness of 1 um, or less is deposited in order to improve the wettability with a solder on an electroless NiXP UBM and to keep the NiXP from being oxidized.
